(19) United States
(12) Patent Application Publication
(10) Pub. No.: US 2012/0154351 A1
(43) Pub. Date: Jun. 21, 2012

(54) METHODS AND APPARATUS TO DETECT AN OPERATING STATE OF A DISPLAY BASED ON VISIBLE LIGHT

(76) Inventor: Michael A. Hicks, Clearwater, FL (US)

(21) Appl. No.: 12/974,659

(22) Filed: Dec. 21, 2010

(51) Int. Cl. G09G 5/00; G01J 3/50

(52) U.S. Cl. 345/207; 356/402

(57) ABSTRACT

Methods and apparatus to infer operating states of a display based on visible light are disclosed. An example device includes an optical receiver to be positioned with respect to a display to receive visible light from the display. The example device includes a sensor to measure a color and an intensity of the visible light received. The example device includes an operating state detector to analyze the measured intensity and color of the visible light detected by the sensor to generate an output indicative of an operating state of the display.

### FIELD OF THE DISCLOSURE

The present disclosure relates generally to audience measurement, and more particularly, to methods and apparatus to detect an operating state of a display based on visible light.

### BACKGROUND

Determining the size and demographics of a television viewing audience helps television program producers improve their television programming and determine a price to be charged for advertising that is broadcast during such programming. In addition, more accurate television viewing demographics allows advertisers to target audiences of a desired size and/or audiences including members having desired characteristics (e.g., income level, lifestyles, interests, etc.).

In order to collect demographic information, an audience measurement company may enlist a number of television viewers to cooperate in an audience measurement study for a length of time. The viewing habits of these enlisted viewers, as well as demographic data about these enlisted viewers, are collected using automated and/or manual collection methods. The collected data is subsequently used to generate a variety of informational statistics related to television viewing audiences including, for example, audience sizes, audience demographics, audience preferences, the total number of hours of television viewing per household and/or per region, etc.

### BRIEF DESCRIPTION OF THE DRAWINGS

FIG. 1 is a block diagram of an example broadcast system constructed in accordance with the teachings of this disclosure.

FIG. 2 is a block diagram of an example display monitoring system.

FIG. 3 is a schematic diagram of a portion of the example display monitoring system of FIG. 2.

FIG. 4 is a front perspective view of example screen of the example display monitoring system of FIG. 2 mounted adjacent a television screen.

FIG. 5 is a block diagram representation of an example display monitoring system.

FIG. 6 is a flow diagram to detect an operating state of a display based on visible light.

FIG. 7 is a flow diagram to detect an operating state of a display based on visible light.

FIG. 8 is a block diagram of an example processor system configured to detect an operating state of a display based on visible light.

As used in this patent, stating that any part (e.g., a component, module, subsystem, device, control, probe, injector, imager, etc.) is in any way positioned on (e.g., positioned on, located on, disposed on, or formed on, etc.) another part, means that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

In the illustrated example, television sets and their surrounding environments are monitored to gather audience measurement data. Knowledge of an on/off state of the television set may be used to reduce an amount of data processing and matching by selectively activating the data processing/matching so that audience measurement data is captured, processed, and/or matched only while the television is on, rather than twenty-four hours a day. An ambient light sensor, for example, may be used to detect and determine whether a television set is on or off.

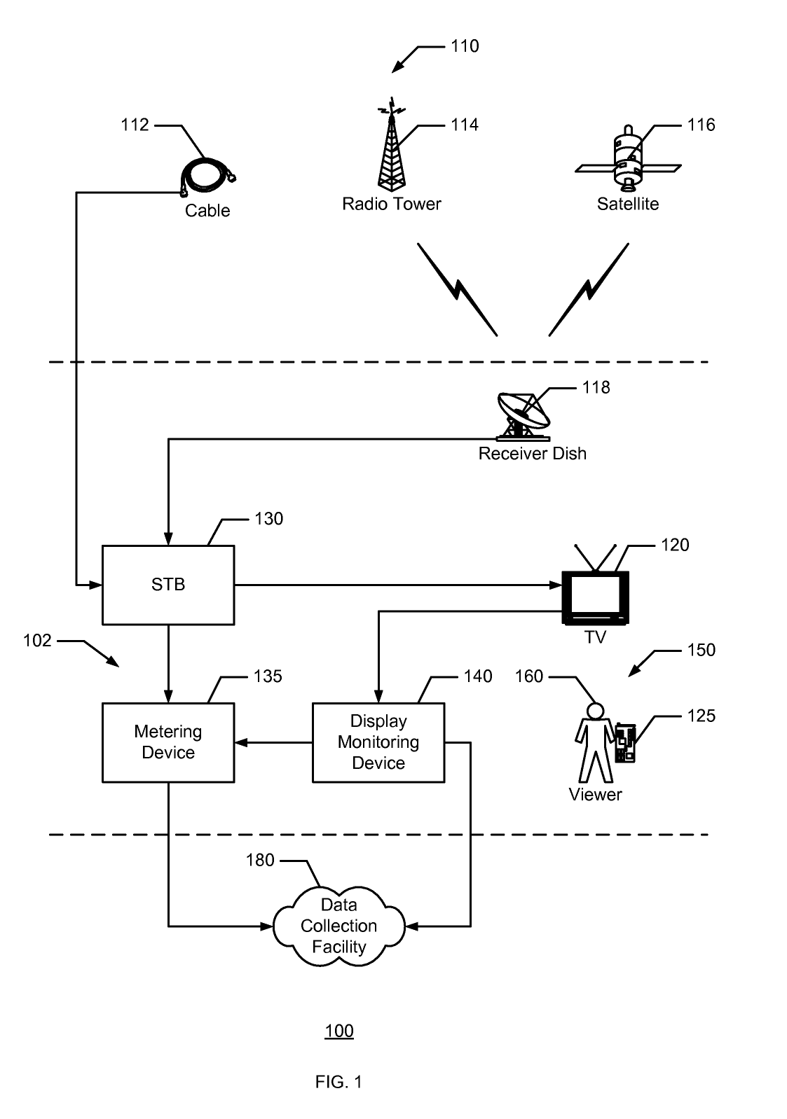

In the example of FIG. 1, an example broadcast system 100 including a service provider 110 delivers content to a monitored household 102. The monitored household 102 of the illustrated example includes a television 120, a remote control device 125, and a set top box (STB) 130. Exposure to media via the television 120 is metered using an audience measurement system; some of which 135, 140 is located in the monitored household 102. In the illustrated example, the television 120 (e.g., a cathode ray tube (CRT) television, a liquid crystal display (LCD) television, a plasma television, etc.) is positioned in a viewing area 150 located within a house 102 occupied by one or more people, referred to as household members 160. Although described as a television herein, television 120 may be any type of content display device such as a computer monitor.

The viewing area 150 includes the area in which the television 120 is located and from which the television 120 may be viewed by one or more household members 160 located in the viewing area 150. In the illustrated example, a metering device 135 is configured to monitor the STB 130 and to collect viewing data to determine the viewing habits of the household members 160. The television 120 and the STB 130 may be powered independently such that the STB 130 may be configured to remain turned on at all times while the television 120 may be turned on or off depending on whether one or more of the household members 160 decides to watch television. Accordingly, the broadcast system 100 of the illustrated example also includes a display monitoring device 140 configured to detect an operating state of the television 120 (e.g., on or off) and to generate data indicative of the operating state. The generated data of the operating state may then be used, for example, to supplement the data collected by the metering device 135 and/or to control the collection of data by the metering device 135. For example, television operating state data may be used to determine whether data collected by the metering device 135 corresponds to television signals that were not only supplied to the television 120 but to television signals that were actually displayed by the television 120. In other examples, the television operating state data generated by the display monitoring device 140 is used to control the operation of the metering device 135. In some such examples, the display monitoring device 140 generates a control signal that causes the metering device 135 to begin collecting metering data in response to detecting that the television 120 is turned on. The display monitoring device 140 may also generate a control signal that causes the metering device 135 to stop collecting metering data in response to detecting that the television 120 is turned off. Thus, the display monitoring device 140 reduces the amount of data collected by the metering device 135, which, in turn, allows for a reduction in the amount of memory required to store metering data. Such reduction in memory may be substantial especially for systems that employ metering devices configured to generate data intensive signatures characterizing the television content.

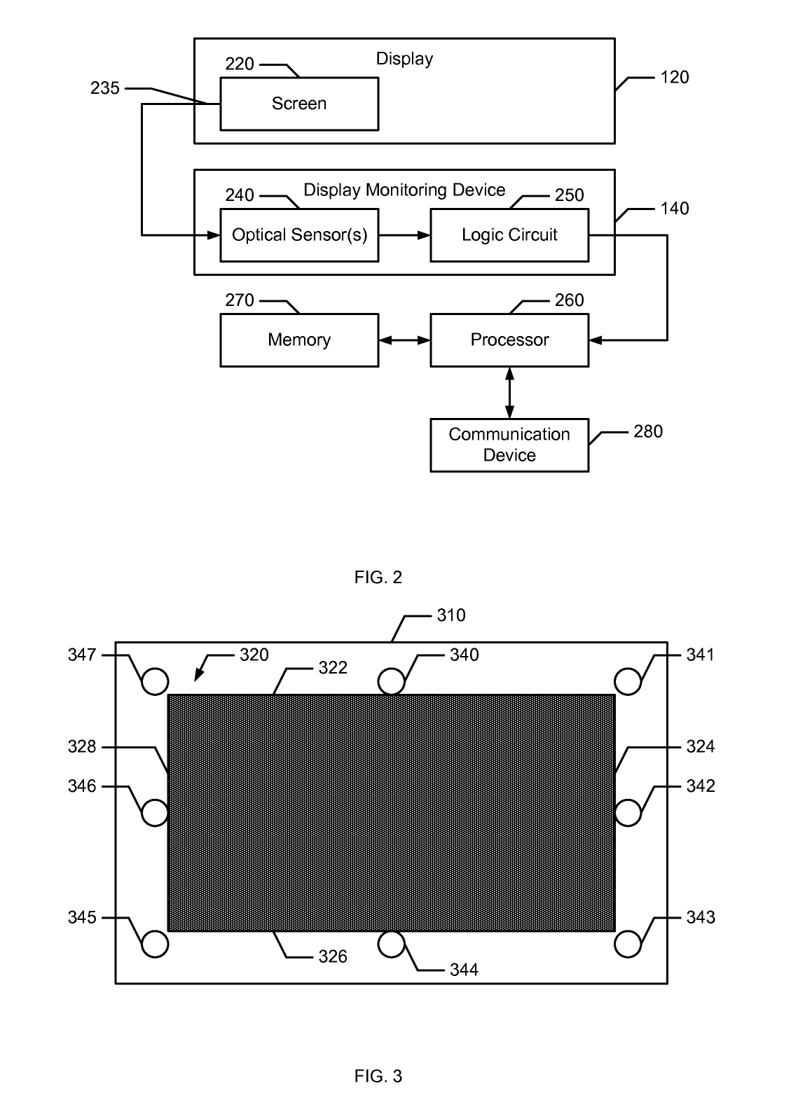

The display monitoring device 140 of the illustrated example may also be configured to determine the total number of hours of television watched by the household members 160. As described in detail below, the display monitoring device 140 may generate time stamps corresponding to the times at which the television 120 is turned on (e.g., begins to display content) and/or the times at which the television 120 is turned off (e.g., stops displaying content). Alternatively, the display monitoring device 140 may be configured to provide the television operating state data to the metering device 135, which in turn, generates time stamps associated with the data so that the total number of hours of television watched may be calculated therefrom. Further, the display monitoring device 140 may provide the television operating state data to the central data collection facility 180 either directly or via the metering device 135. If the display monitoring device 140 directly provides the television operating state data to the data collection facility 180 then the display monitoring device 140 may include a communication device (the device 280 in FIG. 2) such as a wired or wireless telephone communication circuit, a cable modem, etc. The data collection facility 180 of the illustrated example is configured to process and/or store data received from the display monitoring device 140 and/or the metering device 135 to produce television viewing information.

The service provider 110 may be implemented by any service provider such as, for example, a cable television service provider 112, a radio frequency (RF) television service provider 114, and/or a satellite television service provider 116. The television 120 and the STB 130 receives a plurality of television signals transmitted via a plurality of channels by the service provider 110 and may be adapted to process and display television signals provided in any format such as a National Television Standards Committee (NTSC) television signal format, a high definition television (HDTV) signal format, an Advanced Television Systems Committee (ATSC) television signal format, a phase alteration line (PAL) television signal format, a digital video broadcasting (DVB) television signal format, an Association of Radio Industries and Businesses (ARIB) television signal format, etc.

The user-operated remote control device 125 allows a user to cause the television 120 and the STB 130 to tune to and receive signals transmitted on a desired channel, and to cause the television 120 and the STB 130 to process and present the programming content contained in the signals transmitted on the desired channel. The processing performed by the television 120 and the STB 130 may include, for example, extracting a video and/or an audio component delivered via the received signal, causing the video component to be displayed on a screen/display associated with the television 120, and causing the audio component to be emitted by speakers associated with the television 120. The programming content contained in the television signal may include, for example, a television program, a movie, a radio program, an advertisement, a video game, and/or a preview of other programming content that is currently offered or will be offered in the future by the service provider 110.

While the STB 130 and the television 120 are depicted as separate structures, the functions performed by these structures may be integrated within a single unit or may be implemented using two or more separate components. Further, although the television 120, the STB 130, and the metering device 135 are depicted as separate structures, two or more of the television 120, the STB 130, and/or the metering device 135 may be integrated into a single unit. In other examples, two or more of the STB 130, the television 120, the metering device 135, and/or the display monitoring device 140 may also be integrated into a single unit.

FIG. 2 illustrates an example manner of implementing the display monitor 140. The example display monitor 140 of FIG. 2 monitors the television 120 (as referred to as display 120. The display 120 may be implemented by any desired type of display such as a liquid crystal (LCD), a plasma display, and a cathode ray tube (CRT) display. The display 120 includes a screen 220 that projects images by emitting light energy when power is applied to the display 120 (e.g., the display 120 is turned on). The screen 220 is turned off (e.g., blank) when no power is applied to the display 120 and/or when the display 120 enters a standby state, a sleep state, and/or a power save state (e.g., power is applied to the display 120 but the screen 220 is blank).

The example display monitoring device 140 of FIG. 2 is optically coupled to the screen 220 of the display 120. In particular, the display monitoring device 140 includes a positionable light pipe 235, an optical sensor 240, and a logic circuit 250. As described in detail below, the positionable light pipe 235 of the illustrated example is disposed relative to the screen 220 of the display 120 to detect visible light emanating from the screen and to transmit the light to the optical sensor 240. The optical sensor 240 converts the visible light into an electrical signal. The positionable light pipe 235 of the illustrated example may be one or more strands of fiber optics, for example. For example, the optical sensor 240 may be a photodetector (e.g., phototransistors, photoresistors, photocapacitors, photovoltaics such as solar cells, and/or a photodiode) and/or any other suitable light-sensitive semiconductor junction device able to convert light energy emitted by the screen 220 into an electrical signal. Alternatively, the positionable light pipe 235 and the optical sensor 240 may be implemented by using a camera or a transparent waveguide to relay the light energy from the screen 220 through the positionable light pipe 235 to the optical sensor 240. The visible light captured by the optical sensor 240 may be analyzed by signal processing and/or pattern matching to determine information associated with the captured visible light such as raw light intensity (e.g., luminance) and/or color (e.g., chrominance) and/or a change in intensity and/or color compared to a threshold value, for example. The electrical signal may be used to generate information to determine an operating state of the display 210 as described in detail below.

In the example of FIG. 2, the electrical signal is provided to the logic circuit 250, which in turn, generates an output signal indicative of an operating state of the display 120 based on the electrical signal. In particular, the output signal indicates either an on state or an off state of the display 120. For example, the logic circuit 250 may generate a HIGH signal (e.g., a logic “1”) to indicate that the display 120 is turned on (e.g., light energy to project images on the screen 220 is detected). In contrast, the logic circuit 250 may generate a LOW signal (e.g., a logic “0”) to indicate that the display 120 is turned off (e.g., no light energy to project images on the screen 220 is detected).

In the example of FIG. 2, a processor 260 employs the output signal indicative of the operating state of the display 210 to track when and how long the display 120 is turned on or off. In the illustrated example, the processor 260 generates a time stamp corresponding to the time when the processor 260 receives a HIGH signal as the output signal. The processor 260 may generate another time stamp when the processor 260 receives a LOW signal as the output signal. The example processor 260 of FIG. 2 is operatively coupled to a memory 270 to store the on/off information. The memory 270 may be implemented by any type of memory such as a volatile memory (e.g., random access memory (RAM)), a nonvolatile memory (e.g., flash memory) or other mass storage device (e.g., a floppy disk, a CD, and a DVD). The processor 260 may automatically provide operating information (e.g., when the display 120 was turned on or off as indicated by the time stamp) to the data collection facility 180 via a communication device 280 (e.g., a wired or wireless telephone communication circuit, a cable modem, etc.). As noted above, the data collection facility 180 is configured to produce television viewing data. For example, the data collection facility 180 may use the on/off information to determine a total number of hours that the household members 160 watch television and/or to credit/not credit viewing of particular programs logged by the metering device 135 based on the on/off state of the display 120.

While the components shown in FIG. 2 are depicted as separate structures, the functions performed by some of these structures may be implemented using more or less structure than those shown in FIG. 2. For example, the structure of FIG. 2 may be integrated within a single unit or may be implemented using two or more separate components. For example, although the display monitoring device 140 and the processor 260 are depicted as separate structures, the display monitoring device 140 and the processor 260 may be integrated into a single unit. Further, the processor 260 may be configured to generate the output signal indicative of the operating state of the display 120 based on the electrical signal from the signal processing circuit 244 (e.g., the processor 260 may replace the logic circuit 250). The memory 270 may also be integrated into the display monitoring device 140.

As noted above, the positionable light pipe 235 and the optical sensor 240 of the illustrated example are disposed relative to the screen 220 of the display 120 to detect visible light emanating from the screen 220 and to convert the visible light into an electrical signal. FIG. 3 illustrates an example implementation of the screen 220 and the light pipe 235 in more detail. In the example illustrated in FIG. 3, the positionable light pipe 235 is disposed adjacent to an edge 322 of a screen 220. That is, the positionable light pipe 235 extends from the edge 322 to detect visible light emanating from the screen 220. To improve accuracy of the display monitoring device 140, one or more positionable light pipes (generally shown as 341, 342, 343, 344, 345, 346, and 347) may be disposed adjacent to the other edges (generally shown as 324, 326, and 328) of the screen 220. Thus, visible light emanating from any portion of the screen 220 may be monitored.

As illustrated, for example, in FIG. 3, one or more positionable (e.g., bendable) light pipes 235, 340-347 may be aimed at the screen 220 from an edge or side 322, 324, 326, 328 of the screen 320 so as to detect and measure light emitted by the screen 320 while not obscuring the display. The positionable light pipes 235, 340-347 may be positioned to allow light to enter from one direction and accept light emitted from the screen 220 at a particular angle, for example.

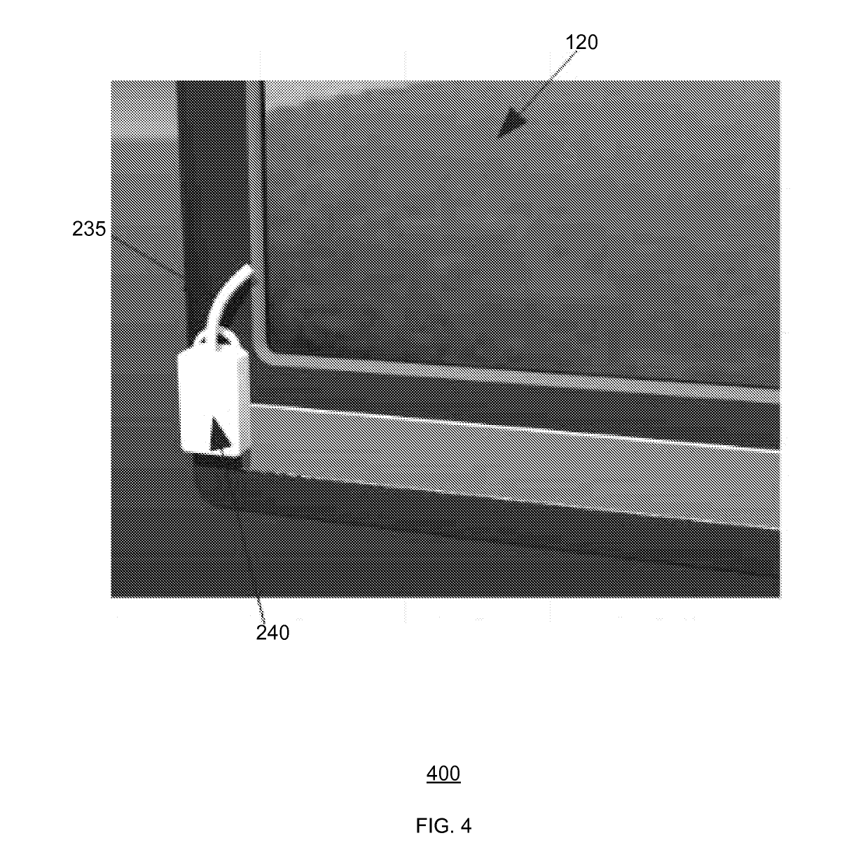

An example implementation of a light pipe 235 and an optical sensor 240 is shown in FIG. 4. As illustrated in the example of FIG. 4, the light pipe 235 is attached to the sensor 240 and is positioned with respect to a display 120. The example sensor 240 collects data based on light (e.g., color, intensity, and/or duration) carried by the light pipe 235 to the sensor 240. The sensor or detector 240 of the illustrated example is in wireless communication with a metering device 135.

In the example of FIG. 4, light from the display 120 collected by the light pipe 235 and communicated to the sensor 240 is indicative of an operating state (e.g., on or off) of the display 120, for example. Operating state information for the display 120, for example, can be used in conjunction with program or content information to measure and evaluate what a viewer of the display 120 is actually exposed to. For example, knowledge of the on/off state of the display 120 can be used to reduce an amount of data processing and/or matching involved in processing program or content information by selectively storing and/or discarding content information with the metering device 135. Processing only data collected when the operating state of the display 120 is on can help save data processing and computer resources and/or deliver results more quickly, for example.

As shown in the example of FIG. 4, an operating state of a display 120 can be determined by positioning a light detector directly on the screen of the display 120. Such positioning, however, may obstruct the user's view of the display 120. Alternatively, using a bendable light pipe (e.g., a pipe, tube and/or fiber that allows light to enter) that is positioned to the side of the display 120 and aimed at the screen 220 can be used to measure light emitted from the display 120 without obscuring the display 120.

To prevent false reporting of an “on” state due to ambient lighting in a room that may be reflected off the display 120 at an angle to be detected by the light pipe 235, a color of light can also be measured. A variation in color, which may occur in television video content but will not occur in light reflections, may be used as additional verification of an “on” state for the television. An intensity and/or duration (e.g., a flickering) of detected light can additionally or alternatively be used as an indication of an “on” or “off” state of the display 120, for example. In certain examples, a change or variation the measured color and/or intensity can be compared to a threshold (e.g., a threshold set by a user and/or statistically determined based on experimental data) to determine whether a change in color and/or intensity has in fact occurred.

For example, a rapid change in a color and/or intensity of detected light (e.g., light detected, captured, and/or otherwise recorded using a positionable optical sensor, high speed camera, etc.) can indicate a flicker that can be used to inform a system that a monitored display is currently on. Absence of a flicker may indicate that the display is off and/or may trigger further color and/or intensity analysis, for example. Liquid crystal displays (LCDs) and cathode ray tube (CRT) displays, for example, exhibit a flicker when viewed through a high speed camera. This flicker may be used as an indication that the LCD or CRT is on, for example. A digital signal processor (DSP) can be used to measure flicker and exclude or discriminate against an incidental reflection on the display, for example.

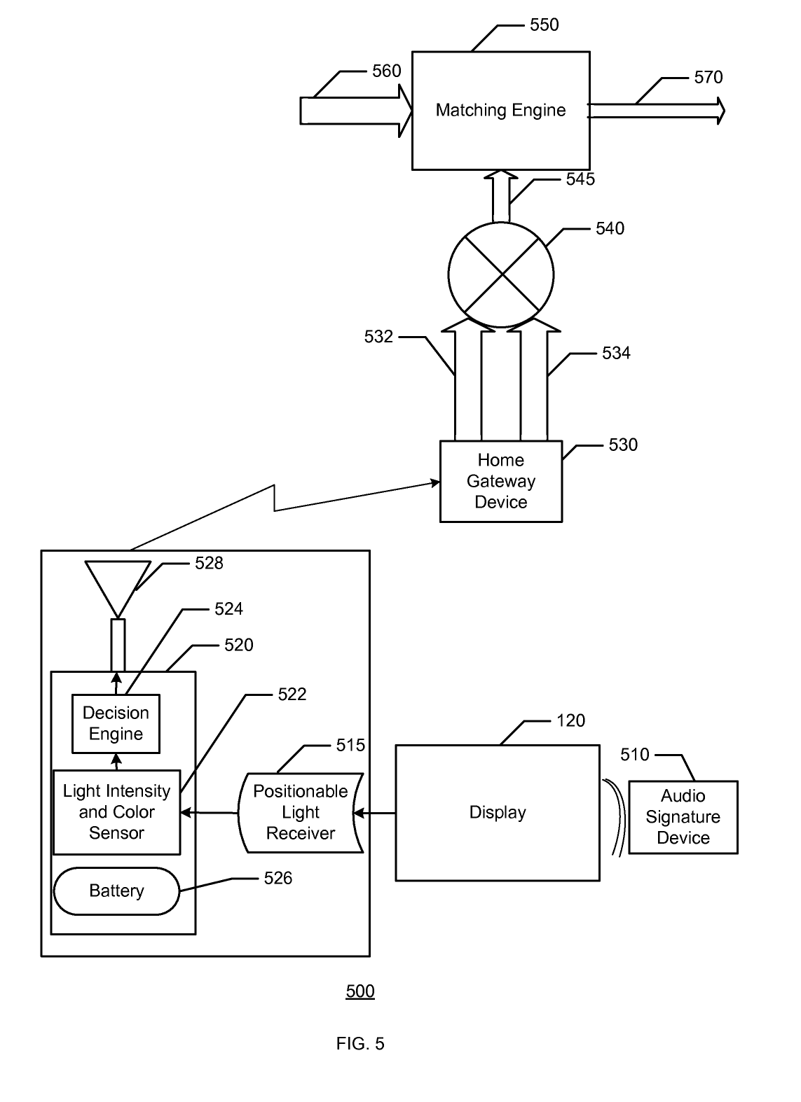

FIG. 5 depicts an example television monitoring system 500. The example system 500 includes a display 120, a signature device 510, a positionable light receiver 515, an operating state detector 520, a home gateway device 530, a matching gate 540, and a back office matching engine 550.

The example light receiver 515 of FIG. 5 is positioned with respect to the display 120 to detect light emitted by the display 120. The example positionable light receiver 515 is connected to and/or in communication with the operating state detector 520. The operating state detector 520 is connected to and/or in communication with a transmitter 528 to transmit information to the home gateway device 530. The signature device 510 (e.g., an audio and/or video signature device) also communicates signature information (e.g., audio from the display 120 and/or from a surrounding room) to the home gateway device 530 in the example system 500.

In the example of FIG. 5, the operating state detector 520 includes a light intensity and color sensor 522, a decision engine 524, and a battery 526. The light receiver 515 (e.g., a positionable light pipe, fiber, or wire 235) receives light from the display 120 and conveys the light to the operating state detector 520. The light intensity and color sensor 522 receives the light from the light receiver 515. Alternatively or additionally, the sensor 522 may be positioned on the end of the receiver 515 at the display 120 rather than with the other components of the operating state detector 520, for example. The sensor 522 processes the received light from the light receiver 515 to generate electronic data representative of the received light and its characteristic(s). For example, an electronic representation of a color, intensity, duration, etc., of the received light is generated by the sensor 522.

The electronic data from the sensor 522 is provided to the decision engine 524 for processing to determine an operating state (e.g., on or off) of the display 505. For example, a color, intensity, duration, and/or a change in any of the color, intensity, and/or duration of the light collected by the receiver 515 is evaluated to determine an operating state of the display 120. For example, a change in color may signify that the display 120 is turned on. A change in intensity from bright to dark may indicate that the display 120 is turned off, for example. A flickering and/or rapid change in color and/or intensity may indicate that the display 505 is turned on, for example.

As depicted in the example of FIG. 5, the operating state determination generated by the decision engine 524 is transmitted to the home gateway device 530 via the transmitter 528. The home gateway device 530 receives on/off operating state information 532 from the transmitter 528 and signature information 534 from the signature device 510 and provides the information 532, 534 to the matching gate 540.

As shown in the example system 500, the matching gate 540 processes the received signature information 534 based on the operating state information 532 to generate a reduced set of signatures 545. For example, if the operating state information 532 indicates that the display 120 is off, the signature information 534 for that time period is removed by the matching gate 540 such that a reduced set of signatures 545 is provided to the back office matching engine 550. Thus, in the example of FIG. 5, the reduced set of signatures 545 includes signature information 534 for time(s) at which the operating state information 532 indicates the display 120 was turned on. The back office matching engine 550 analyzes the reduced set of signatures 545 with respect to a universe of viewing content and time signatures 560 to provide content viewing information 570 to an external source, such as a database, analytics engine, market analyst, customer, etc.

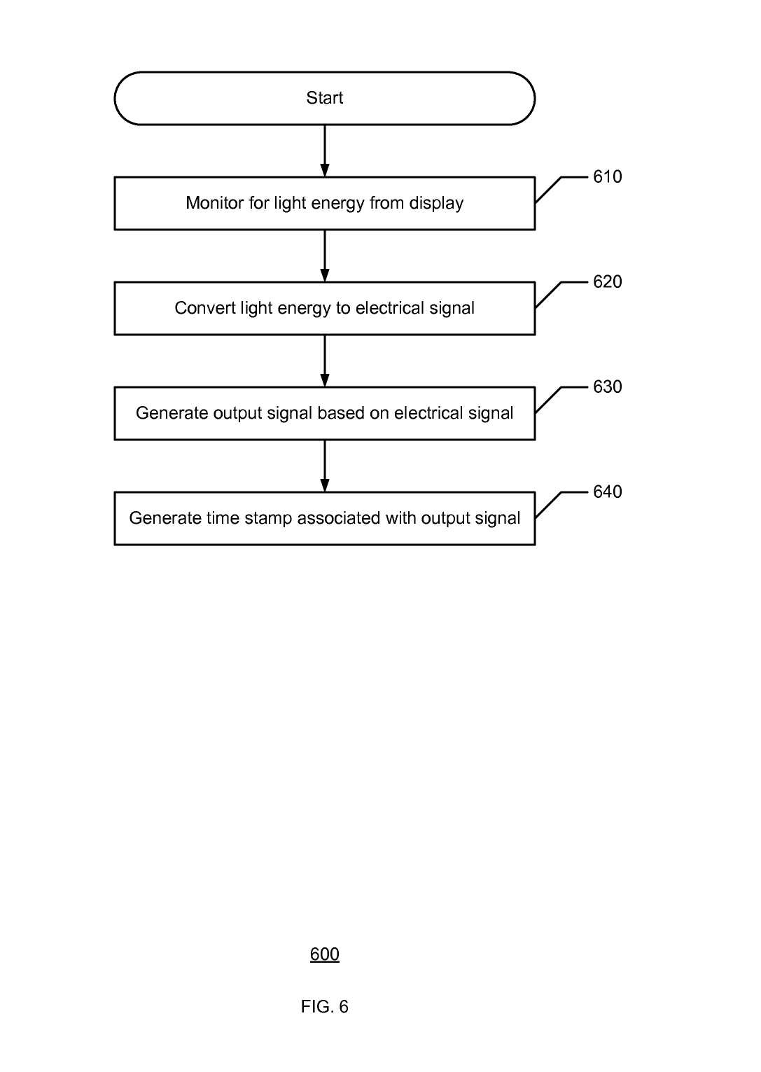

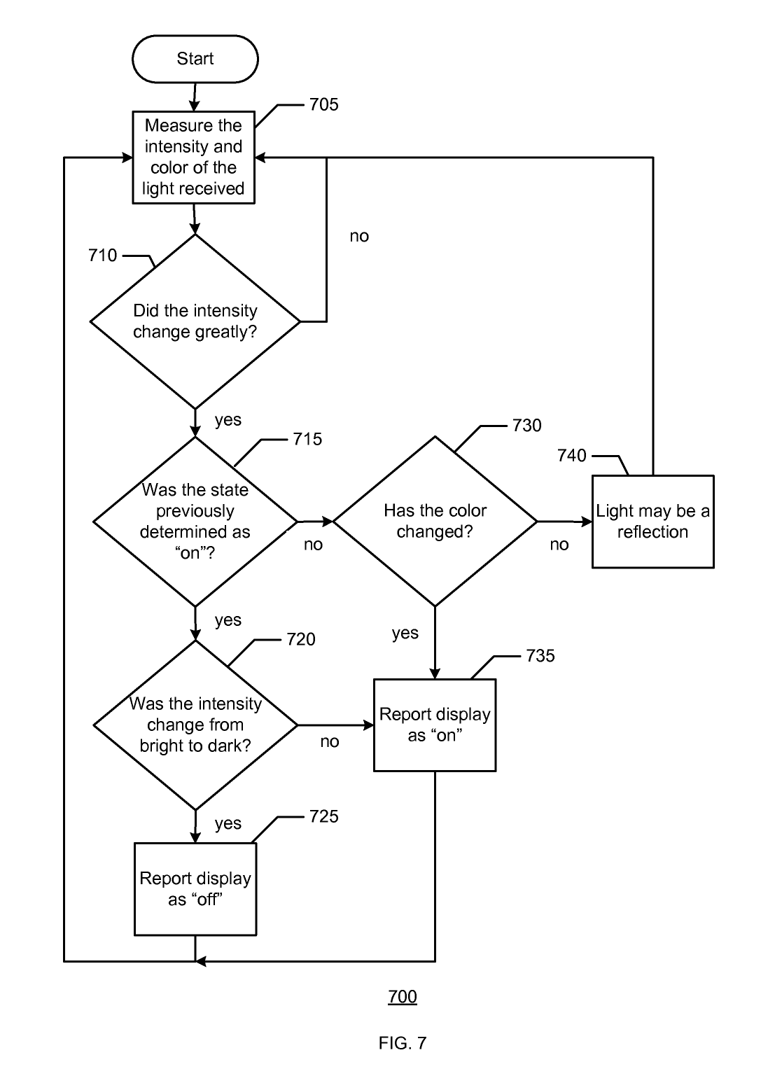

FIGS. 6-7 are flow diagrams representative of example machine readable instructions that can be executed to implement the example systems of FIGS. 1-5 and/or portions of one or more of those systems. The example processes of FIGS. 6-7 can be performed using a processor, a controller and/or any other suitable processing device. For example, the example processes of FIGS. 6-7 can be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIGS. 6-7 can be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIGS. 6-7 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 6-7 can be implemented manually or as any combination(s) of any of the foregoing techniques, for example, any combination of firmware, software, discrete logic and/or hardware. Further, although the example processes of FIGS. 6-7 are described with reference to the flow diagrams of FIGS. 6-7, other methods of implementing the processes of FIGS. 6-7 can be employed. For example, the order of execution of the blocks can be changed, and/or some of the blocks described can be changed, eliminated, sub-divided, or combined. Additionally, any or all of the example processes of FIGS. 6-7 can be performed sequentially and/or in parallel by, for example, separate processing threads, processors, devices, discrete logic, circuits, etc.

An example method which may be executed to detect an operating state of a display is illustrated in FIG. 6. Although a particular order of actions is illustrated in FIG. 6, the flow chart of a method 600 is merely provided as an example of one way to detect an operating state of the display 120.

In the example of FIG. 6, the light receiver 515 (e.g., including the optical fiber 235) is optically coupled to the screen 220 associated with the display 120 (block 610). As noted above, the screen 220 is configured to emit light energy when it displays images. The display monitoring device 140, 520 monitors for light from the screen 220 via the optical fiber 235 and/or other light receiver 515 (block 620). The optical sensor 240, 522 converts light from the screen 220 to an electrical signal (block 630). The electrical signal is amplified to a particular voltage level and filtered to remove extraneous signals (e.g., noise) from the electrical signal (e.g., using pre-processing circuitry in conjunction with the sensor 240, 522 and/or logic circuit 250, 524) (block 640). The logic circuit 250, 524 generates an output signal indicative of an operating state of the display (block 650). In particular, the output signal is indicative of whether the display 120 is in an on state or an off state. For example, the logic circuit 250, 524 may generate a HIGH signal (i.e., a logic “1”) to indicate that the display 120 is turned on. Alternatively, the logic circuit 250, 524 may generate a LOW signal (i.e., a logic “0”) to indicate that the display 120 is turned off including a standby state where the screen 220 is blank.

For example, to prevent false reporting of an “on” state due to ambient lighting in a room that may be reflected off the display 120 at an angle to be detected by the light receiver 235, 515, a color of light can also be measured. A variation in color, which may occur in television video content but will not occur in light reflections, may be used as additional verification of an “on” state for the television. An intensity and/or duration (e.g., a flickering) of detected light can be used as an indication of an “on” or “off” state of the display 120, for example. For example, measured color and/or intensity can be measured and compared to a threshold and/or other parameter to determine whether a change or variation has occurred with respect to the color and/or intensity to indicate that the television 120 is “on” and is providing content rather than “off” and perhaps only incidentally reflecting light to the light receiver 235, 515.

For example, a rapid change in a color and/or intensity of detected light (e.g., light detected, captured, and/or otherwise recorded using a positionable optical sensor, high speed camera, etc.) can indicate a flicker that can be used to inform a system that a monitored display is currently on. Absence of a flicker may indicate that the display is off and/or may trigger further color and/or intensity analysis, for example. Liquid crystal displays (LCDs), for example, exhibit a flicker when viewed through a high speed camera. This flicker may be used as an indication that the LCD is on, for example.

Whenever there is a change in the state of the output signal from the logic circuit 250, 524, the processor 260, 524 generates a time stamp (block 660). For example, when the processor 260, 524 first detects a HIGH signal from the logic circuit 250, 524, the processor 260, 524 generates a time stamp and stores data indicating that the display 120 entered an on state at the time indicated by the time stamp. When the processor 260, 524 detects a LOW signal from the logic circuit 250, 524 it generates a time stamp and stores data indicating that the display 120 entered an off state at the time indicated by the time stamp.

Operating information (e.g., when the display 120 was turned on or off), may be provided to the data collection facility 180 and/or provided to the metering device 135, 530 that subsequently transmits the operating information to the data collection facility 180, 550. The operating information may be used to produce television audience statistics. As noted above, the operating information may be used to credit viewership to programs and/or advertisements that were actually presented to viewers. Further, as noted above, the operating information may also be used to reduce and/or to filter out data 534 that is collected by the metering device 135, 530. The data collection facility 180 may thus use the operating information to separate the viewing data corresponding to programming content that was actually displayed from the viewing data corresponding to programming content that was merely provided to the television 120 when the television 120 was turned off.

An example flow diagram providing further detail for a method 700 to determine an operating state of a display is shown in FIG. 7. Although a particular order of actions is illustrated in FIG. 7, the flow chart of a method 700 is merely provided as an example of one way to use the display monitoring device 520 to detect an operating state of the display 120.

As depicted in the example of FIG. 7, at block 705, received light is measured, such as by the light receiver 235, 515 and the light sensor 240, 522. An intensity, color, and/or duration of the received light can be measured, for example. At block 710, a change in intensity, for example, is determined If the intensity did not change beyond a certain threshold level, then the received light is re-measured at block 705. A lack of change in intensity may indicate no change in a previously determined operating state of the display 120, for example.

If the intensity of the received light has changed beyond a certain threshold, then, at block 715, the previously determined operating state is evaluated. If the previously determined operating state is found to be “on”, then, at block 720, the light is further examined. If the previously determined operating state was “off”, then, at block 730, a color change is evaluated.

At block 720, the change in light intensity is evaluated. If the intensity change was from bright to dark, then, at block 725, the operating state of the display 120 is reported to be “off”. If the intensity change was not from bright to dark, then, at block 735, the operating state of the display 120 is reported to be “on”.

At block 730, the color of the received light is evaluated. If the color has changed from the previously recorded color, then, at block 735, the operating state of the display 120 is reported to be “on”. If the color has not changed from the previously observed color, then, at block 740, the received light is classified as a possible reflection, and, at block 705, the received light is re-measured for further analysis. In certain examples, an output indication of the operating state of the display is smoothed (e.g., using a digital signal processor) for transmission to a content monitoring system.

As shown in the example method 700, of FIG. 7, after the operating state of the display 120 has been updated and reported, the received light is again measured and analyzed beginning at block 705.

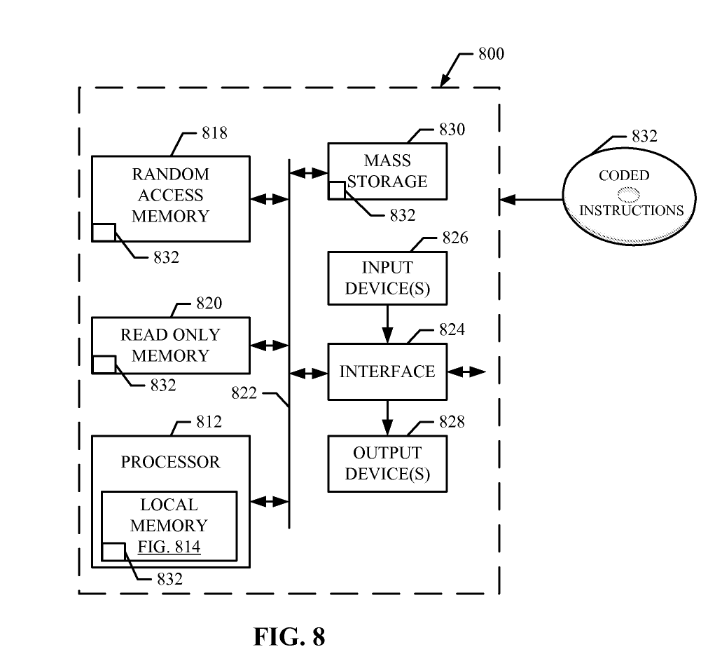

FIG. 8 is a block diagram of an example computer 800 capable of executing the instructions of FIGS. 6-7 to implement the apparatus of FIGS. 1, 2, 3 4, and/or 5. The computer 800 can be, for example, a server, a personal computer, a mobile phone (e.g., a cell phone), a personal digital assistant (PDA), an Internet appliance, a DVD player, a CD player, a digital video recorder, a personal video recorder, a set top box, or any other type of computing device.

The system 800 of the instant example includes a processor 812. For example, the processor 812 can be implemented by one or more Intel® microprocessors from the Pentium® family, the Itanium® family or the XScale® family. Of course, other processors from other families are also appropriate.

The processor 812 is in communication with a main memory including a volatile memory 818 and a non-volatile memory 820 via a bus 822. The volatile memory 818 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 820 may be implemented by flash memory and/or any other desired type of memory device. Access to the main memory 814 is typically controlled by a memory controller (not shown).

The computer 800 also includes an interface circuit 824. The interface circuit 824 may be implemented by any type of interface standard, such as an Ethernet interface, a universal serial bus (USB), and/or a PCI express interface.

One or more input devices 826 are connected to the interface circuit 824. The input device(s) 826 permit a user to enter data and commands into the processor 812. The input device(s) can be implemented by, for example, a keyboard, a mouse, a touchscreen, a track-pad, a trackball, isopoint and/or a voice recognition system.

One or more output devices 828 are also connected to the interface circuit 824. The output devices 828 can be implemented, for example, by display devices (e.g., a liquid crystal display, a cathode ray tube display (CRT), a printer and/or speakers). The interface circuit 824, thus, typically includes a graphics driver card.

The interface circuit 824 also includes a communication device (e.g., communication device 280) such as a modem or network interface card to facilitate exchange of data with external computers via a network (e.g., an Ethernet connection, a digital subscriber line (DSL), a telephone line, coaxial cable, a cellular telephone system, etc.).

The computer 800 also includes one or more mass storage devices 830 for storing software and data. Examples of such mass storage devices 830 include floppy disk drives, hard drive disks, compact disk drives and digital versatile disk (DVD) drives. The mass storage device 830 may implement the memory 270 and/or other data storage, for example.

The coded instructions 832 of FIGS. 6-7 may be stored in the mass storage device 830, in the volatile memory 818, in the non-volatile memory 820, in the local memory 814, and/or on a removable storage medium such as a CD or DVD.

The computer 800 can work in conjunction with one or more microcontrollers, such as the display monitoring device 140, 230, logic circuit 250, operating state detector 520, sensor 522, and/or decision engine 524, etc., to measure and analyze light information to generate an operating state output. Microcontrollers can include one or more of a variety of integrated circuits including a processor core, memory, programmable inputs/outputs, etc. Examples include, but are not limited to, Freescale Coldfire MCF521X, Atmel AVR32, TI Stellaris 1000, Microchip PIC32, etc. In certain examples, the computer 800 can be implemented and/or integrated with one or more microcontrollers, for example.

Although the following discloses example systems including, among other components, software executed on hardware, it should be noted that such systems are merely illustrative and should not be considered as limiting. For example, it is contemplated that any or all of the disclosed hardware and software components could be embodied exclusively in dedicated hardware, exclusively in software, exclusively in firmware or in some combination of hardware, firmware, and/or software.

In addition, while the following disclosure discusses example television systems, it should be understood that the disclosed system is readily applicable to many other media systems. Accordingly, while the following describes example systems and processes, the disclosed examples are not the only way to implement such systems.

While the methods, apparatus, and articles of manufacture disclosed herein are particularly well suited for use with a television, the teachings of the disclosure may be applied to detect an operating state of other types of display. For example, the methods, apparatus, and articles of manufacture disclosed herein may detect an operating state of a computer monitor, a projector screen, and/or other media output device. Thus, the methods, apparatus, and articles of manufacture disclosed herein may collect data associated with Internet usage and/or other display of media via a computer.

Although certain example methods, apparatus, and articles of manufacture have been described herein, the scope of coverage of this patent is not limited thereto. On the contrary, this patent covers all methods, apparatus, and articles of manufacture fairly falling within the scope of the claims of this patent either literally or under the doctrine of equivalents.

1. A device comprising:
an optical receiver to be positioned with respect to a display to receive visible light from the display;
a sensor to measure a color and an intensity of the visible light received; and
an operating state detector to analyze the measured intensity and color of the visible light detected by the sensor to generate an output indicative of an operating state of the display.

2. The device of claim 1, wherein the operating state detector is to examine the measured color of the visible light when measured intensity changed from a prior state.

3. The device of claim 1, wherein the operating state generator is to provide the output indicative of the operating state to gate at least one of audio and video signature information.

4. The device of claim 3, wherein the output is to gate the at least one of audio and video signature information to provide a reduced set of signatures to a matching engine.

5. The device of claim 1, wherein the optical receiver comprises a positionable light pipe.

6. The device of claim 1, wherein the operating state detector comprises a decision engine and a transmitter.

7. The device of claim 1, wherein the operating state detector is to analyze the visible light received by the optical receiver to identify a flicker to indicate that the operating state of the display is on.

8. The device of claim 7, wherein the sensor comprises a camera to capture the flicker.

9. The device of claim 1, wherein the optical receiver is disposed adjacent an edge of the display.

10. The device of claim 1, wherein the operating state detector is to associate a time stamp with the output indicative of the operating state of the display.

11. A system comprising:
a screen to emanate visible light; and
an operating state detector disposed to detect an operating state of the screen based on light received from an optical receiver positioned to receive visible light from the screen, the operating state detector to detect a color change in the visible light to determine an operating state of the screen.

12. The system of claim 11, wherein the operating state detector is to examine the measured color of the visible light when the measured intensity changed from a prior state.

13. The system of claim 11, wherein the operating state generator is to smooth the output to be generated indicative of the operating state of the display for transmission to a content monitoring system.

14. The system of claim 11, wherein the operating state generator is to provide the output indicative of the operating state to gate at least one of audio and video signature information received from an environment surrounding the display.

15. The system of claim 14, wherein the output is to gate the at least one of audio and video signature information to provide a reduced set of signatures to a matching engine.

16. The system of claim 11, wherein the optical receiver comprises a positionable light pipe.

17. The system of claim 11, wherein the operating state detector comprises a decision engine and a transmitter.

18. The system of claim 11, wherein the operating state detector is to analyze the visible light received by the optical receiver to identify a flicker to indicate that the operating state of the display is on.

19. The system of claim 18, wherein the operating state detector comprises a camera to capture the flicker.

20. The system of claim 11, wherein the optical receiver is disposed adjacent an edge of the screen.

21. The system of claim 11, wherein the operating state detector is to associate a time stamp with the output indicative of the operating state of the display

22. A method comprising:
monitoring for visible light emanated from a screen of a display;
detecting a change in an intensity of the visible light; and
generating an output indicative of the operating state of the display based on the intensity change.

23. The method of claim 22, wherein detecting the intensity change further comprises:
detecting a color of the visible light when the intensity changes by more than a threshold; and
examining the color of the visible light to identify a change in the color.

24. The method of claim 22, further comprising gating at least one of audio and video signature information received from an environment surrounding the display based on the output indicative of the operating state of the display to provide a reduced set of signatures to a matching engine.

25. The method of claim 22, wherein the analyzing further comprises analyzing the visible light received to identify a flicker to indicate that the operating state of the display is on.

26. The method of claim 22, further comprising associating a time stamp with the output indicative of the operating state of the display.

27. An article of manufacture comprising:
a computer readable storage medium; and
executable program instructions embodied in the computer readable storage medium that when executed by a programmable system cause the system to implement a method comprising:
monitoring for visible light emanated from a screen of a display;
detecting an intensity change in the visible light; and
generating an output indicative of the operating state of the display based on the intensity change.
